(19) United States
(12) Patent Application Publication
(10) Pub. No.: US 2026/0316709 A1
(43) Pub. Date: Oct. 15, 2026

(54) Torsion Clip for Providing a Fastening Option for a Component of a Vehicle Airbag System

(71) Applicant: Illinois Tool Works Inc., Glenview, IL (US)

(72) Inventors: Kouzali Louay, Kaiserslautern (DE); Thiemo Ammann, Rockenhausen (DE); Markus Elsner, Kaiserslautern (DE)

(21) Appl. No.: 19/573,187

(22) Filed: Mar. 20, 2026

(30) Foreign Application Priority Data
Apr. 9, 2025 (DE) 10 2025 113 917.2

(51) Int. Cl. B60R 21/21; B60R 21/232

(52) U.S. Cl. CPC B60R 21/21; B60R 21/232

(57) ABSTRACT

A fastening assembly for securing an airbag system is provided. The fastening assembly includes a torsion clip having an anchor component with an anchor region and a bearing region, a housing component configured to rotatably support the bearing region, and a cover component disposed over at least a portion of the housing component. The anchor component is movable relative to the housing component between an initial state, an intermediate state, and a mounted state. During insertion of the anchor region into an opening, the anchor component rotates in a first rotational direction and returns toward a neutral position upon reaching the intermediate state, and subsequently rotates in a second rotational direction opposite the first rotational direction during transition to the mounted state.

### RELATED APPLICATION

The present application claims the benefit of German Patent Application No. 10 2025 113 917.2, filed Apr. 9, 2025, titled “Torsion Clip for Providing a Fastening Option for a Component of a Vehicle Airbag System,” the contents of which are hereby incorporated by reference.

### BACKGROUND

Airbag systems are typically supplied as component assemblies that are subsequently mounted to a vehicle body using installation approaches intended to be as simple and efficient as possible.

The airbag systems considered herein include, in particular, side impact airbags and curtain-type airbags configured for installation on a vehicle structure. Such systems are commonly mounted behind vehicle pillars, along seat structures, or in roof-adjacent regions of the vehicle. Curtain-type airbags, for example, are typically positioned along lateral upper regions of the vehicle, such as above front and rear doors.

Airbags are widely used safety devices in the automotive industry and, in combination with other passive safety components such as seatbelts, contribute significantly to reducing occupant injury and mortality during collisions. Testing data and real-world statistics have demonstrated that airbags, particularly when used in conjunction with seatbelt systems, can substantially improve occupant protection in both frontal and side-impact events.

Modern vehicle platforms may incorporate multiple types of airbags, including front airbags for driver and passenger protection in frontal impacts, as well as side airbags and curtain-type airbags for lateral protection. Curtain-type airbags, in particular, are subject to strict performance requirements, including rapid deployment timing, sufficient inflation duration, and reliable positioning during deployment.

Various challenges are associated with the integration and mounting of such airbags within a vehicle. For example, packaging constraints within the vehicle structure often limit available space, particularly in roof-adjacent regions. Additionally, there is typically only a limited distance between the vehicle body and the occupant, and minimal structural material between the occupant and an external impact. As a result, airbags must deploy within fractions of a second and generate substantial forces during deployment, which are transmitted to their associated fastening components.

These high deployment forces can place significant mechanical demands on fastening assemblies used to secure the airbags to the vehicle structure. Accordingly, fastening systems must be capable of maintaining secure attachment under such dynamic loading conditions while also accommodating manufacturing and assembly constraints.

Further challenges arise during installation and service procedures. The installation of new airbags, or the replacement of deployed airbags, is often a time-consuming process. Such processes may include disassembly of existing fasteners, removal of the airbag assembly, installation of a replacement airbag, and reattachment or adjustment of fastening components.

In many cases, installation requires manual assembly of clip components or fastening elements to the airbag, followed by insertion or engagement of the assembled components with portions of the vehicle structure to secure the airbag in place. These steps can increase assembly time, complexity, and potential for installation variability.

### SUMMARY OF THE DISCLOSURE

The present disclosure relates generally to an airbag clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, a fastening clip known from the prior art for providing a fastening possibility for an airbag system.

FIG. 2 illustrates schematically and in an isometric view, an exemplary embodiment of the airbag clip configured as a torsion clip according to the disclosure, in the initial state of the airbag clip.

FIG. 3 illustrates schematically and in an isometric view, the exemplary embodiment of the airbag clip according to the disclosure in the mounted state.

FIG. 4 illustrates schematically and in an isometric exploded view, the exemplary embodiment of the airbag clip according to the disclosure.

FIG. 5A illustrates schematically and in an isometric view, the exemplary embodiment of the airbag clip according to the disclosure in its initial state prior to insertion of the anchor component of the airbag clip into an opening provided in a carrier component (body).

FIG. 5B illustrates schematically and in an isometric view, the exemplary embodiment of the airbag clip according to FIG. 5A, after a first sub-region of the anchor component has been inserted into the opening provided in the carrier component (body).

FIG. 5C illustrates schematically and in an isometric view, the exemplary embodiment of the airbag clip according to FIG. 5B in a state in which the anchor component of the airbag clip is further inserted into the opening provided in the carrier component (body), and the airbag clip has been transferred from the initial state according to FIG. 5A to an intermediate state according to FIG. 5C.

FIG. 5D illustrates schematically and in an isometric view, the exemplary embodiment of the airbag clip according to FIG. 5C, after the airbag clip has been transferred from the intermediate state shown in FIG. 5C to a mounted state.

FIG. 6A illustrates schematically and in an isometric view, the exemplary embodiment of the airbag clip according to the disclosure according to FIG. 5A, wherein the airbag clip is additionally provided with an airbag holding component.

FIG. 6B illustrates schematically and in an isometric view, the exemplary embodiment of the airbag clip according to the disclosure according to FIG. 5D, wherein the airbag clip is provided with the airbag holding component shown in FIG. 6A.

FIG. 7A illustrates schematically and in a plan view of the anchor component from below, the exemplary embodiment of the airbag clip according to the disclosure in its initial state.

FIG. 7B illustrates schematically and in a bottom view of the anchor component of the airbag clip in a state, in which the airbag clip is transferred from its initial state to the intermediate state.

FIG. 7C illustrates schematically and in a bottom view of the anchor component of the exemplary embodiment of the airbag clip according to the disclosure, in a state in which the airbag clip has been transferred to its intermediate state.

FIG. 7D illustrates schematically and in a bottom view of the anchor component of the exemplary embodiment of the airbag clip according to the disclosure, after the airbag clip has been transferred to its mounted state.

FIG. 8 illustrates schematically and in an isometric view, the anchor component of the exemplary embodiment of the airbag clip according to the disclosure.

FIG. 9 illustrates schematically and in an isometric view, the housing component of the exemplary embodiment of the airbag clip according to the disclosure.

FIG. 10 illustrates schematically and in an isometric view, the anchor component of FIG. 8 received at least in regions in the housing component of FIG. 9, of the exemplary embodiment of the airbag clip according to the disclosure.

FIG. 11 illustrates schematically and in an isometric view, the cover component of the exemplary embodiment of the airbag clip according to the disclosure.

FIG. 12 illustrates schematically and in a cross-sectional view of the triggering mechanism of the exemplary embodiment of the airbag clip according to the disclosure.

FIG. 13 illustrates schematically and in an isometric view, the airbag holding component of the exemplary embodiment of the airbag clip according to the disclosure, configured as an airbag holder.

FIG. 14 illustrates schematically and in a plan view from below of the airbag holder according to FIG. 12.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to a fastening arrangement for securing a vehicle component to a carrier component, such as a vehicle body component. In particular, the vehicle component may comprise an interior component, and more specifically, a component of a vehicle airbag system or an airbag system assembly.

More specifically, the present disclosure relates to a fastening arrangement configured to secure a component of an airbag system to a body-side mounted portion within a vehicle. The body-side mounted portion may be referred to herein as a vehicle body component or a carrier component. The disclosed fastening arrangement is configured to provide an optimized interface between the airbag system component and the carrier component.

Airbag systems, including side impact airbags and curtain-type airbags, are commonly incorporated into vehicle structures at various locations, such as along pillars, seat structures, or roof-adjacent regions. Curtain-type airbags, for example, are typically positioned along upper lateral regions of a vehicle, such as above front and rear doors, where packaging space may be constrained and integration with surrounding vehicle structures is required.

Such airbag systems are configured to operate in conjunction with other vehicle safety systems, such as seatbelts, to enhance occupant protection. In operation, these systems are designed to deploy rapidly and to maintain structural integrity and positioning during deployment and inflation.

The integration of such systems within a vehicle presents a number of design considerations. For example, available packaging space within the vehicle structure may be limited, particularly in roof-adjacent regions. Additionally, fastening arrangements are required to accommodate dynamic loading conditions associated with deployment, including rapid actuation and force transmission through the mounted components.

Further considerations include the installation and serviceability of airbag systems. For example, assembly processes may involve coupling fastening components to the airbag system and securing the assembly to the vehicle structure. These processes may involve multiple steps, including positioning, engagement, and retention of fastening features relative to the carrier component.

Accordingly, there is a need for fastening arrangements that facilitate secure attachment of airbag system components to vehicle structures while accommodating packaging constraints, supporting dynamic loading conditions, and enabling efficient assembly and installation.

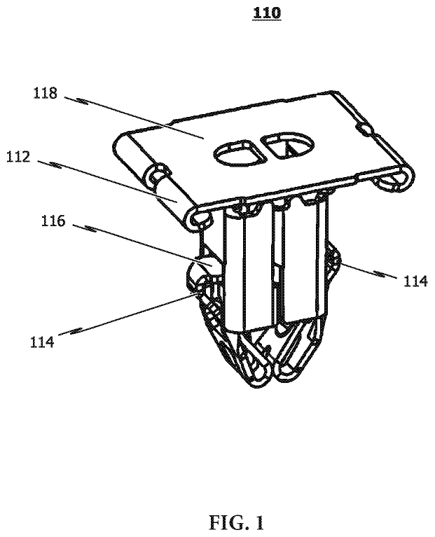

By way of illustration, FIG. 1 depicts an example fastening assembly 110 configured for securing an airbag system component, such as a side impact or curtain-type airbag, to a vehicle structure. In the illustrated example, the fastening assembly 110 includes a fastening clip having a body portion and a head section 112 extending therefrom. The fastening clip 110 may be formed from a material selected to accommodate loading conditions associated with operation of the airbag system, including forces generated during deployment.

The head section 112 of the metal clip (fastening clip 110) has a lower surface that abuts an outer surface of a fastening plate of the vehicle when the fastening clip 110 is inserted into it. The fastening clip 110 further includes laterally projecting tenons 114, the upper surfaces 116 of which are configured to rest against an inner surface of the fastening plate such that the panel surface between the head section 112 and the upper surfaces 116 of the tenons 114 is “clamped.”

The fastening clip 110 is configured to provide either an unstressed connection, in which the tenons 114 merely prevent the fastening clip 110 from being displaced from the mounting opening after installation, or a connection that is stressed only when the dimensions of the panel surface (thickness) and the opening (rectangular cut-out) are suitably matched to the clip construction.

In the case of an unstressed connection (i.e., without elastic springs), the biasing or spring force may be provided by another component of the airbag module.

The fastening clip 110 further has a flat upper surface 118, against which the installer presses when inserting the fastening clip 110 into the mounting opening.

However, it may be difficult for the installer to recognize that the fastening clip 110 has reached a final mounted position. As a result, the installer may spend an unnecessary amount of time pushing the fastening clip 110 further into the panel, or more importantly, may not be aware that a fastening clip 110 is incorrectly mounted in the panel. Incorrectly mounted fastening clips 110 may then unexpectedly fail when the airbag is triggered.

The task of the present disclosure is to provide an optimized assembly for providing a fastening possibility for a vehicle component, in particular for a component of an airbag system or for an airbag system, which in particular are side impact airbags or curtain-type airbags.

In particular, the fastening assembly is intended to be a fastening assembly that is formed entirely of plastic to avoid sharp-edged regions of the fastening assembly, as is necessarily the case with metal mounting clips.

According to preferred embodiments, the fastening assembly is also particularly capable of providing instant feedback to the installer during mounting, clearly indicating that the fastening assembly has reached its final mounted position.

Accordingly, the disclosure relates to a fastening possibility for a vehicle component, in particular for a component of an airbag system, wherein the assembly is configured as a torsion clip. The assembly configured as a torsion clip comprises an anchor component, a housing component and a cover component and is thus configured in a total of three parts.

The anchor component of the fastening assembly, which is configured as a torsion clip, preferably comprises an anchor region that is at least partially or in regions at least substantially shaft-shaped or bar-shaped and an associated and in particular at least substantially flange-shaped or plate-shaped bearing region.

The housing component of the fastening assembly, which is configured as a torsion clip, is in particular configured to receive at least partially or in regions at least the bearing region of the anchor component such that—at least via a previously determined or determinable rotational angle range—the anchor component is rotatably supported relative to the housing component about an axis of rotation extending at least substantially in the longitudinal extension direction of the anchor region.

The cover component of the fastening assembly configured as a torsion clip is in particular configured to cover the housing component at least partially or in regions with the bearing region of the anchor component that is received at least partially or in regions.

According to the disclosure, it is particularly provided that the assembly is configured such that the assembly is transferred or can be transferred from an initial state to an intermediate state and from the intermediate state to a mounted state, particularly when inserting, in particular plugging, the anchor region of the anchor component into an opening provided in a carrier component. In particular, the anchor component is configured such that, when transferring the assembly from the initial state to the intermediate state, starting from a neutral position relative to the housing component, the anchor component is rotated in a first rotational direction about the axis of rotation.

Upon reaching the intermediate state or in the intermediate state of the assembly, the anchor component moves back to the neutral position on its own. On the other hand, when transferring the assembly from the intermediate state to the mounted state, the anchor component, starting from the neutral position relative to the housing component, is rotated about the axis of rotation in a second rotational direction opposite to the first rotational direction.

In particular, the anchor component, the housing component and the cover component configured as a torsion clip are each configured as preferably fiber-reinforced plastic parts, in particular a plastic injection-molded parts.

According to preferred implementations of the fastening assembly according to the disclosure and configured as a torsion clip, it is provided that the cover component is mounted in a linearly movable, in particular linearly displaceable, manner with respect to the housing component between a first position and a second position.

The cover component is in particular in the first position when the assembly is in the intermediate state, wherein the cover component is preferably in the second position when the assembly is in the mounted state.

In this context, it is appropriate for the assembly to be configured such that, to transfer the assembly to the mounted state, linear movability and in particular linear displaceability of the cover component relative to the housing component is only permitted when it is detected by the assembly that the anchor region of the anchor component has been inserted, in particular plugged, into the opening provided in the carrier component, and that the assembly has been transferred from the initial state to the intermediate state.

Thus, in an easy-to-implement but still effective manner, feedback is provided to the installer, clearly indicating that the fastening assembly has reached its final mounted position.

According to design variants of this embodiment of the fastening assembly which is configured as a torsion clip, it is provided that the assembly has a corresponding triggering mechanism that is actuated as soon as the anchor region of the anchor component has been inserted, in particular plugged, into the opening provided in the carrier component, and the assembly has been transferred from the initial state to the intermediate state.

Preferably, when the triggering mechanism is actuated, the linear movability, and in particular the linear displaceability, of the cover component relative to the housing component is enabled.

In the implementations of the fastening assembly according to the disclosure, the cover component is arranged in a rotationally fixed manner with respect to the housing component and comprises a torsion element, which interacts with the anchor component and in particular with the anchor region of the anchor component such that, when the assembly is transferred from the initial state to the intermediate state, the torsion element is rotated so that a torque is generated to move the anchor component back to the neutral position.

In this context, it may in particular be provided that the torsion element and/or the anchor component is/are configured such that, when the assembly is transferred from the intermediate state to the mounted state, an interaction between the torsion element and the anchor component is canceled so that the torsion element is not rotated.

According to preferred implementations of the fastening assembly according to the disclosure and configured as a torsion clip, it is provided that the anchor component is at least in regions configured as a hollow body and the torsion element is at least partially or in regions received in the interior of the anchor component, which is at least in regions configured as a hollow body.

In this case, it is conceivable that at least in the initial state of the assembly, an end region of the torsion element projects at least partially or in regions from a wall region of the anchor component, which is at least in regions configured as a hollow body.

According to further developments of this design variant, a passage opening is formed in the anchor region of the anchor component, through which, at least in the initial state of the assembly, the end region of the torsion element extends at least partially or in regions.

Preferably, the passage opening formed in the anchor region of the anchor component is positioned and/or formed in the anchor region of the anchor component such that the end region of the torsion element, which extends at least partially or in regions through the passage opening at least in the initial state of the assembly, and that, in the intermediate state of the assembly or when transferring the assembly from the intermediate state to the mounted state, comes into contact with a wall region surrounding the opening provided in the carrier component and is pressed through the passage opening into the interior of the anchor component, which is configured at least in regions as a hollow body.

According to further developments of this design variant, or in general, of the fastening assembly configured as a torsion clip, it is provided that the cover component comprises a locking element, which is configured, in a first state of the locking element, to block a movement, in particular a linear movement, of the cover component relative to the housing component, and, in a second state of the locking element, to allow a movement, in particular a linear movement, of the cover component relative to the housing component.

The locking element can be formed by the end region of the torsion element, which extends at least partially or in regions, at least in the initial state of the assembly, through the passage opening.

According to preferred implementations of the fastening assembly according to the disclosure and configured as a torsion clip, the cover component comprises linear guides, which are configured, at least when transferring the assembly from its intermediate state to its mounted state, to interact with corresponding linear guides of the housing component, which are formed at least partially or in regions to be complementarily to the linear guides of the cover component, such that the cover component is movable, in particular linearly movable, relative to the housing component in the longitudinal extension direction of the anchor region.

According to further developments of this design variant, the cover component comprises catch means, which are configured to cooperate with corresponding counter-catch means of the housing component upon or after transferring the assembly from its intermediate state to its mounted state, such that the cover component is fixed to the housing component after its movement relative to the housing component in the longitudinal extension direction of the anchor region.

According to preferred implementations of the fastening assembly according to the disclosure and configured as a torsion clip, it is provided that the anchor component, and in particular the bearing region of the anchor component, comprises at least one ramp-shaped region, and the cover component comprises at least one drive region protruding in the longitudinal extension direction of the anchor region, which is configured in such a way and cooperates with the at least one ramp-shaped region of the anchor component such that, in the case of a movement, and in particular linear movement, of the cover component relative to the housing component in the longitudinal extension direction of the anchor region, a torque acting on the anchor component is generated, in particular according to the principle of the inclined plane.

On the other hand, according to preferred implementations of the fastening assembly according to the disclosure and configured as a torsion clip, it is provided that an end region of the anchor region of the anchor component opposite to the bearing region of the anchor component is configured at least partially or in regions as a guide region with at least one guide surface, which is configured such that, upon insertion, and in particular plugging, of the anchor region into the opening provided in the carrier component, a torque is generated and introduced into the anchor component, such that, starting from the neutral position of the anchor component, the anchor component is rotated relative to the housing component in the first rotational direction about the axis of rotation.

In this context, it is expedient that the anchor region of the anchor component between the guide region and the bearing region comprises at least one rib region projecting radially from the anchor region and preferably two rib regions that are opposite each other, each protruding radially from the anchor region.

In this context, it is conceivable that the at least one rib region radially projecting from the anchor region comprises an upper surface facing the bearing region of the anchor component and a lower surface opposite to the upper surface, wherein, in the mounted state of the assembly, an edge region of the carrier component surrounding the opening provided in the carrier component is at least partially or in regions received between the upper surface of the at least one rib region projecting radially from the anchor region and a downwardly facing surface of the housing component.

Alternatively or additionally to this end, the at least one rib region radially projecting from the anchor region comprises an upper surface facing the bearing region of the anchor component and a lower surface opposite to the upper surface, wherein the lower surface of the at least one rib region radially projecting from the anchor region and a lower region of the passage opening formed in the anchor region of the anchor component are at least substantially in a common plane perpendicular to the axis of rotation.

The fastening assembly configured as a torsion clip, and in particular the anchor component of the assembly, is particularly configured for installation in a standard opening provided in a carrier component for airbag mountings, wherein the standard opening for airbag mountings is in particular rectangular with a dimension of about 7.4 mm×9.4 mm.

On the other hand, according to preferred implementations of the fastening assembly according to the disclosure and configured as a torsion clip, the assembly comprises an anti-rotation device that interacts with an edge region of the carrier component surrounding the opening provided in the carrier component, in particular in the form of a hole/pin combination, which is formed such that, at least when transferring the assembly from the initial state to the intermediate state, the housing component of the assembly is kept rotationally fixed relative to the carrier component.

Finally, it may be provided that the fastening assembly configured as a torsion clip comprises an airbag holding component which is, in particular, releasably connected or connectable to the housing component and/or the cover component of the assembly.

In particular, the fastening assembly configured as a torsion clip can be reversibly transferred between its initial state and its mounted state.

The advantages achievable with the disclosure are clear: in particular, the torsion clip according to the disclosure is an all-plastic airbag clip with installation verification for fastening an airbag or an airbag component to a carrier component of the vehicle, and in particular to a body component. The airbag clip specifically meets the standard hole size of 7.4×9.4 mm for curtain-type airbag applications.

A significant advantage achieved with variants of the airbag clip configured as a torsion clip is that, when using the airbag clip, the risk of the airbag being destroyed or damaged due to sharp metal edges is minimized. This risk cannot be ruled out for airbag clips made of metal.

The prejudice existing in the technical field is overcome, according to which an all-plastic clip cannot be used as an airbag clip due to the high requirements on the holding force when triggering the airbag module and due to the limitation of the hole size for attaching the airbag clip.

Moreover, according to preferred implementations of the disclosure, the airbag clip according to the disclosure has a centering function with an installation verification.

In particular, the airbag clip according to the disclosure is very easy to assemble and disassemble. The airbag clip has a low weight and additionally a comparatively high holding due to the possibility of using glass fiber-reinforced plastic.

In addition, the airbag clip according to the disclosure not only comprises an installation verification, but also a centering function, which uses the rotary-clip or torsion-clip concept to fasten an airbag to the body of the vehicle.

The airbag clip is constructed to continue rotating without deforming the material of the torsion element when the airbag clip is actuated.

An exemplary embodiment of the airbag clip according to the disclosure is described in the following paragraphs, with reference to the accompanying drawings.

Disclosed is a three-part fastening assembly that can be mounted in a procedurally reliable and safe manner and with a high holding force via a multi-stage torsion and rotation mechanism. The benefits resulting from this configuration are diverse. A significant advantage lies in the creation of a fail-safe assembly (“Poka Yoke”). The mechanism, by which the anchor component first rotates in a first direction, then moves back to a neutral position on its own, and ultimately is finally locked by linear movement of the cover component in a second, opposite direction, provides clear and unambiguous feedback to the installer.

The automatic return to the pre-locked intermediate position generates a clearly noticeable and/or audible signal (e.g., a “click”) that signals to the installer that the clip has correctly passed through the opening in the carrier component. Only after this step is the final locking enabled by the depressing of the cover component. This reliably precludes incorrect mounting, in which the clip is not fully anchored in the carrier component, which is of paramount importance, especially for safety-critical components such as airbag systems.

Another advantage of the mechanical principle of the disclosure is overcoming the previous disadvantages of pure plastic clips.

In the automotive industry, there was a long-standing prejudice that all-plastic clips could not provide the required high holding forces for the attachment of airbag modules, particularly within the limited design space and with the hole size specifications.

The assembly according to the disclosure solves this problem by means of intelligent functional distribution and force transmission. The final rotational movement of the anchor component into the final locking position, driven by the linear movement of the cover component via a ramp mechanism, produces an extensive and form-fitting rear engagement with the carrier component. This large contact surface optimally distributes the extreme tensile forces occurring in the event of airbag deployment and prevents the clip from being pulled out.

The separation of the functions across three components also enables materials engineering optimization: The anchor component may be manufactured from a highly rigid, fiber-reinforced plastic to provide maximum holding forces, while the torsion element of the cover component may be made of a more elastic, fatigue-resistant material (e.g., POM).

In addition, the basic configuration, which is purely plastic, offers significant safety and cost advantages. Conventional metal clips carry the risk that their sharp edges will damage the airbag bag during airbag deployment, impairing its function or causing it to fail. An all-plastic clip completely eliminates this risk.

Economically, injection molding manufacturing is significantly less expensive than multi-stage manufacturing of metal or hybrid clips that require stamping, bending, and often assembly processes. The lower weight of the plastic clip also contributes to the weight reduction of the entire vehicle, which in turn lowers fuel consumption and CO₂ emissions.

Various modifications are contemplated as alternative designs to the disclosed configurations. Thus, the geometry of the ramp surfaces on the anchor component and the drive region on the cover component could be varied to adjust the transmission ratio between the linear thrust force and the final rotational movement. Steeper ramps would allow for faster locking with greater force while flatter ramps increase mounting comfort through lower actuation forces.

Likewise, the torsion element could not only be configured as an integral pin, but also as a separate spring component (e.g., a wound torsion spring made of metal or plastic) that acts between the cover and anchor components in order to be able to adjust the return forces more precisely.

A design variant of the disclosure is provided, in which the anchor component comprises an overmolded metal insert. This approach specifically combines the benefits of metal and plastic to achieve maximum performance.

The primary advantage of this hybrid design is the dramatic increase in holding force and general mechanical resiliency without abandoning the core advantages of the torsion locking mechanism. The metal insert, typically a precisely manufactured stamped and bent clip made of high-strength spring steel, is inserted directly into the injection mold and overmolded with plastic. This creates an inseparable composite where the metal insert forms the primary load paths for tensile and shear forces.

The technical effect of this embodiment is targeted structural reinforcement exactly where it is most urgently needed. While the plastic continues to provide the complex geometric functions such as the ramps, the guides and the torsion counterbearing, and also forms a smooth outer surface that protects the airbag, the internal metal insert provides a holding force that far exceeds that of all-plastic parts.

This allows the clip to be used in applications with the most extreme requirements for the holding forces, in which an all-plastic clip would reach its material boundaries. At the same time, the advantages of procedurally reliable and safe mounting are fully retained by the torsion mechanism. The metal insert is completely enclosed by plastic, so that no sharp edges can penetrate to the outside and can endanger the airbag.

In practice, this means that the clip combines the mechanical strength of a metal clip with the functional intelligence and safety of a plastic clip. This “best-of-both-worlds” solution is superior to conventional hybrid clips where metal and plastic parts are often merely assembled together.

Direct overmolding creates a form-fitting and material-locking connection that ensures optimal transfer of force between the materials and prevents delamination or interface failure. This principle allows the wall thicknesses of the plastic to be reduced, which results in a more compact and lighter component compared to a solid plastic clip of the same strength.

Alternative implementations could relate to the design and placement of the metal insert. Instead of reinforcing the entire anchor component, the metal insert could also be placed only partially in highly stressed areas, such as the rear-engaging feet of the anchor, to further optimize weight and cost. It is also conceivable to use different metals, such as aluminum for weight saving or special alloys for increased temperature resistance. Furthermore, the housing component could also be provided with a metal insert to increase its resistance to rotation with respect to the body or to create a particularly robust support for the anchor component.

Another innovative hybrid technology is disclosed, in which a plastic base body is provided with a galvanic metal coating. In contrast to the overmolded metal insert, which increases bulk strength, the galvanic coating is primarily directed at improving surface properties.

The main advantage of this method is the significant increase in surface stiffness and hardness of the plastic component. This results in improved wear resistance and a more precise mechanical function over the entire life of the vehicle.

The technical effect manifests in particular at the functional contact surfaces of the clip. The ramp surfaces of the anchor component and the drive region of the cover component, which slide over one another under high pressure during the final locking, are protected from abrasion and plastic deformation by the hard metal layer (e.g., made of nickel or chromium).

This ensures that the transmission of force required for the rotational movement functions reliably even after many years or under extreme temperature conditions. Likewise, the stiffness of the rear-engaging feet of the anchor and the catch elements is increased, resulting in more precise and durable locking without completely losing the elasticity of the underlying plastic core.

This technology allows the manufacture of components that combine the lightness and geometric design freedom of plastic with the surface hardness and high-quality appearance of metal. The thin but very stiff metal layer allows the construction of thin-walled structures that still have the required stiffness. This is particularly advantageous in order to optimally utilize the limited design space.

A further advantage may be the electrical conductivity of the surface, which may be used to shield against electromagnetic interference (EMI) or to connect to a ground potential. The torsion locking mechanism benefits from this increased precision, resulting in even more defined haptic feedback during assembly.

Various coating materials and methods could be considered as alternative configurations. In addition to nickel and chromium, layers of copper (as a base layer) or special alloys could also be used to further improve corrosion resistance or sliding properties.

It would also be conceivable to selectively apply the coating only to the highly stressed functional surfaces in order to save costs in the manufacturing process. For this purpose, masking methods could be used prior to the galvanizing process. The combination of a galvanic coating on the anchor component with an uncoated cover component could also be advantageous in order to realize optimum sliding and wear behavior between the two components.

The triggering mechanism, the locking element and the linear guides cooperate to compel guided and sequential mounting. This prevents the installer from being able to fully lock the clip in a partially or incorrectly inserted state, which significantly increases the functional safety of the overall system. The locking elements and counter-catches provide permanent and vibration-resistant fixation in the mounted state.

The definition of the torsion element as an integral part of the cover component that engages in a cavity of the anchor component represents a particularly elegant and space-saving solution. The passage opening (9) and the resulting end region of the torsion element form the core of the triggering and locking mechanism. The ramp and drive regions are the key features for converting the linear mounting force into the final, high-strength rotational lock.

The rib regions not only serve to guide and center the anchor in the opening, but also increase the bending strength of the anchor shaft. The design for a standard opening ensures compatibility with existing body designs and facilitates market launch.

The exemplary embodiment described relates to a fastening assembly in the form of an airbag clip suitable for attaching utensils and accessories. The embodiment of the disclosure is commonly employed in vehicles.

Although the disclosure is described with reference to vehicles, the disclosure is not limited to vehicles but may also be used in other structures that require attachment of accessories or peripheral components to a structure.

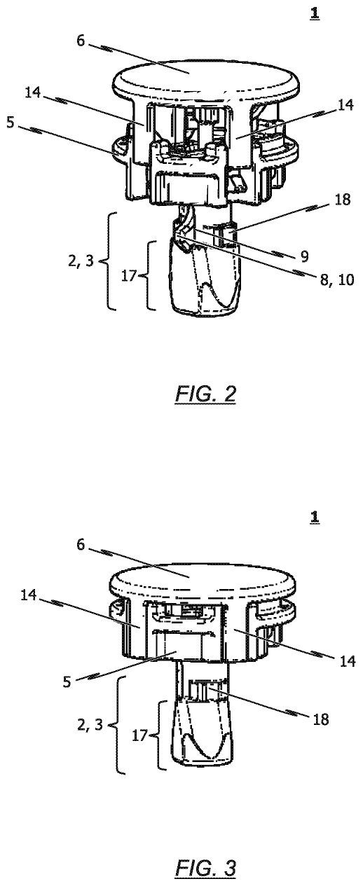

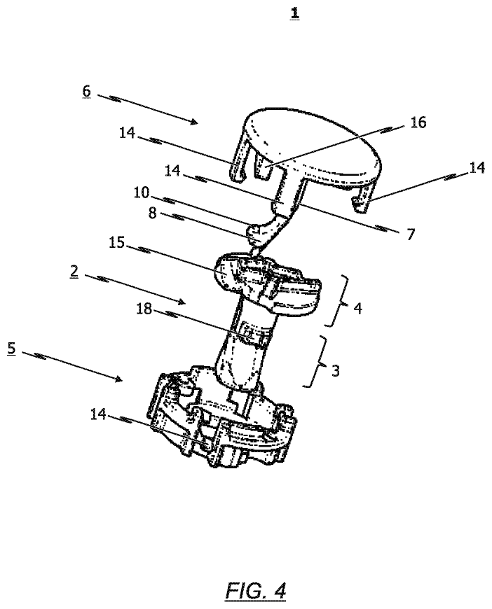

The exemplary embodiment of the fastening assembly according to the disclosure, shown schematically in FIG. 2 to FIG. 14, is configured as a torsion clip and in particular serves as an airbag clip 1 for fastening an airbag, not shown in the drawings, or a component thereof to a vehicle carrier component 50.

As can in particular be seen from the illustrations in FIG. 2 to FIG. 4, the airbag clip 1 comprises an anchor component 2 with an anchor region 3 that is in particular at least partially or in regions at least substantially shaft-shaped or bar-shaped, and with a bearing region 4 connected thereto that is in particular at least substantially flange-shaped or plate-shaped, as well as a housing component 5, which is configured at least partially or in regions to at least receive the bearing region 4 of the anchor component 2 such that—at least over a previously determined or determinable range of rotational angles—the anchor component 2 is rotatably mounted relative to the housing component 5 about an axis of rotation that extends at least substantially in the longitudinal extension direction of the anchor region 3.

Furthermore, the airbag clip 1 comprises a cover component 6, which is configured to cover at least partially or in regions the housing component 5 with the bearing region 4 of the anchor component 2 received at least partially or in regions.

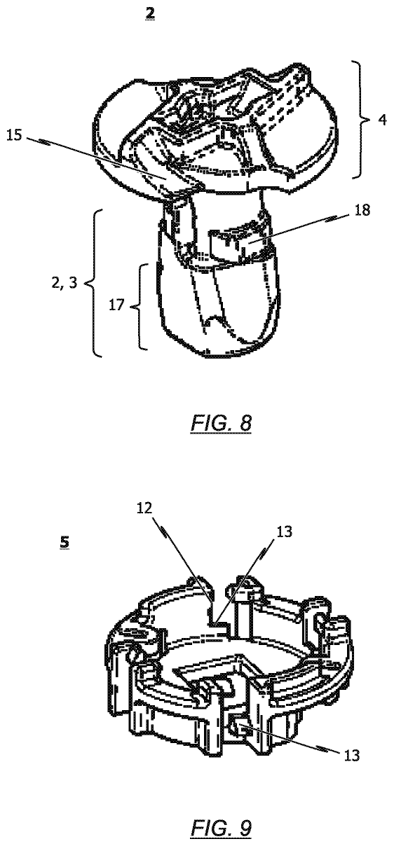

The anchor component 2 of the airbag clip 1 is also shown in a single illustration in FIG. 8, while in FIG. 9 the housing component 5 of the airbag clip 1 is shown individually.

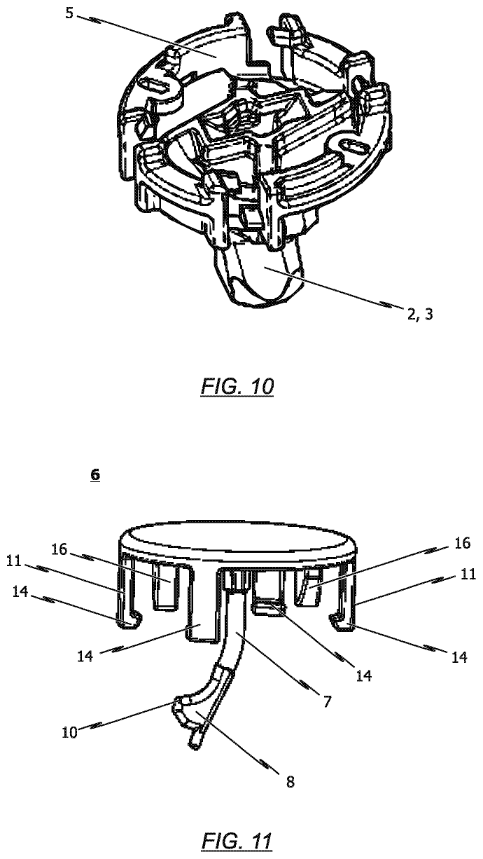

In FIG. 10, the anchor component 2 of the airbag clip 1 is shown in its state, in which it is received at least partially or in regions by the housing component 5.

FIG. 11 shows the cover component 6 of the airbag clip 1 in a single illustration.

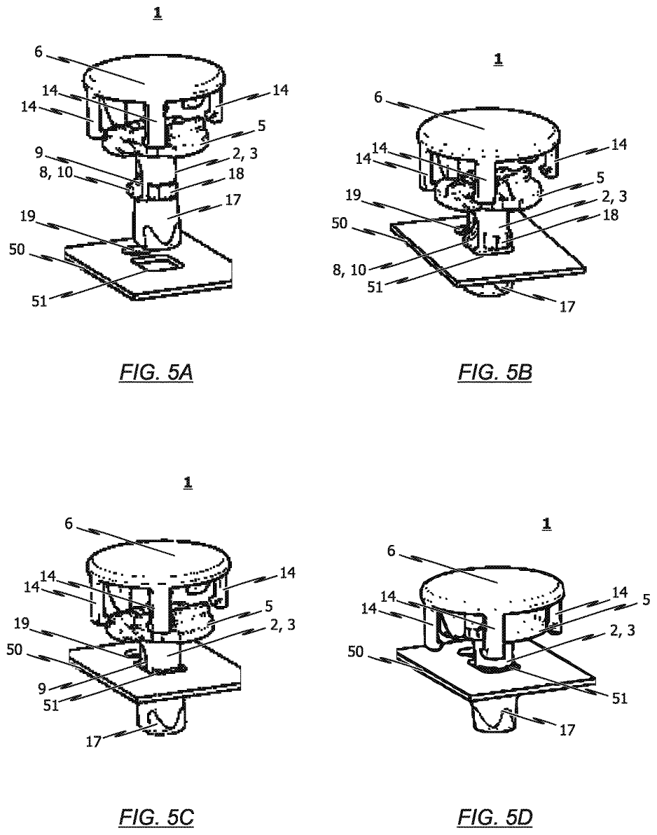

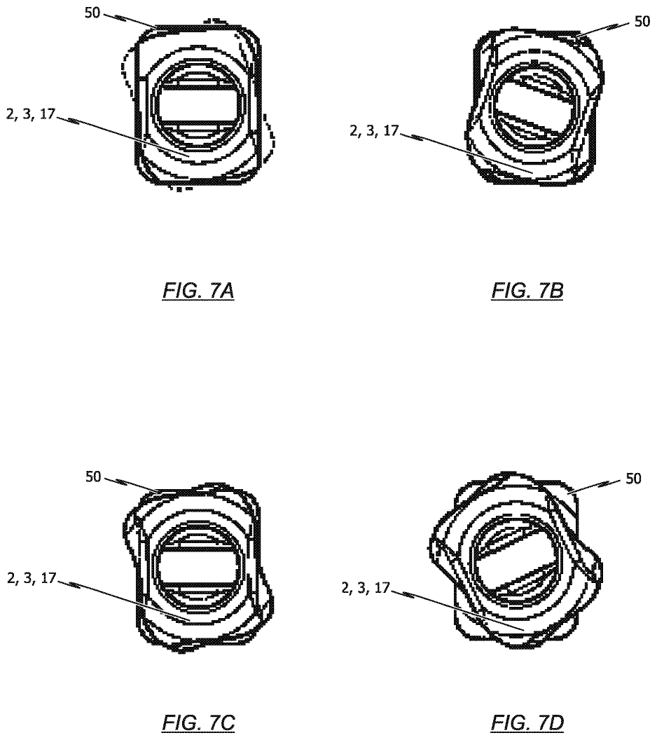

As can in particular be seen in the illustrations in FIG. 5A to FIG. 5D and the illustrations in FIGS. 7A-7D, the airbag clip 1 is configured such that, particularly when inserting, and preferably plugging, the anchor region 3 of the anchor component 2 into an opening 51 provided in a carrier component 50, it is or can be transferred from an initial state to an intermediate state and from the intermediate state to a mounted state, wherein the anchor component 2 is configured such that, when transferring the airbag clip 1 from the initial state to the intermediate state, starting from a neutral position relative to the housing component 5, the anchor component 2 is rotated in a first rotational direction about the axis of rotation, wherein, upon reaching the intermediate state or in the intermediate state of the airbag clip 1, the anchor component 2 moves back to the neutral position on its own, and wherein, when transferring the airbag clip 1 from the intermediate state to the mounted state, the anchor component 2, starting from the neutral position relative to the housing component 5, is rotated about the axis of rotation in a second rotational direction opposite to the first rotational direction.

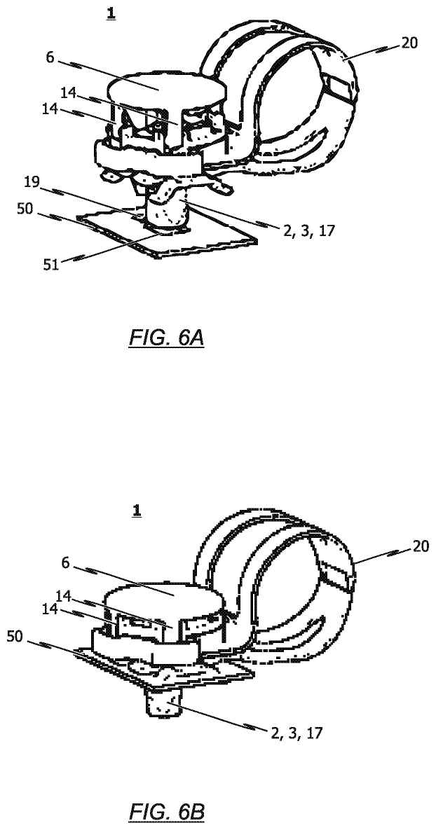

On the other hand, FIG. 5A and FIG. 5D or FIG. 6A and FIG. 6B, show that the cover component 6 is mounted in a linearly movable, and in particular linearly slidable, manner relative to the housing component 5 between a first position and a second position, wherein the cover component 6 is in the first position when the airbag clip 1 is in the intermediate state, and wherein the cover component 6 is in the second position when the airbag clip 1 is in the mounted state.

The airbag clip 1 is configured such that, to transfer the airbag clip 1 to the mounted state, linear movability and in particular linear displaceability of the cover component 6 relative to the housing component 5 is only permitted when it is detected by the airbag clip 1 that the anchor region 3 of the anchor component 2 has been inserted, in particular plugged, into the opening 51 provided in the carrier component 50, and that the airbag clip 1 has been transferred from the initial state to the intermediate state.

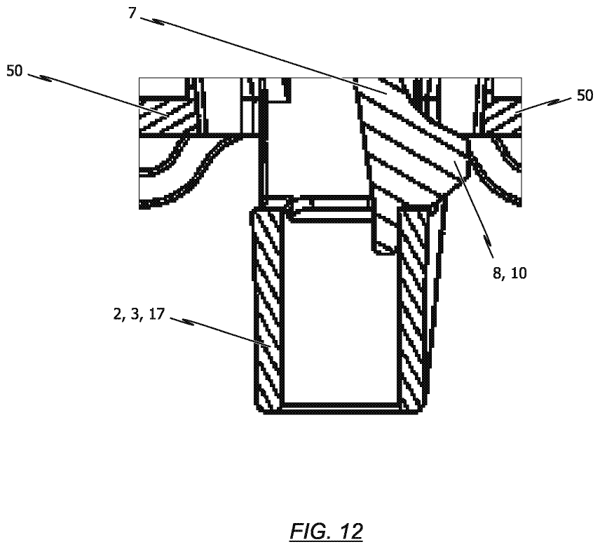

As can in particular be seen in the sectional view according to FIG. 12, the airbag clip 1 comprises a triggering mechanism 8, which is actuated as soon as the anchor region 3 of the anchor component 2 has been inserted, in particular plugged, into the opening 51 provided in the supporting component 50, and the airbag clip 1 has been transferred from the initial state to the intermediate state. This is also illustrated in FIG. 5B and FIG. 5C.

When the triggering mechanism 8 is actuated, the linear movability, and in particular the linear displaceability, of the cover component 6 relative to the housing component 5 is enabled.

In particular, the cover component 6 is arranged in a rotationally fixed manner with respect to the housing component 5 and comprises a torsion element 7 integrally formed with the housing component 5, as can be seen in particular in FIG. 11.

The torsion element 7 interacts with the anchor component 2, and in particular with the anchor region 3 of the anchor component 2 such that, when the assembly 1 is transferred from the initial state to the intermediate state, the torsion element 7 is rotated so that a torque is generated to move the anchor component 2 back to the neutral position.

As can in particular be seen from the sectional view according to FIG. 12, the torsion element 7 and/or the anchor component 2 is/are configured such that, when the airbag clip 1 is transferred from the intermediate state to the mounted state, an interaction between the torsion element 7 and the anchor component 2 is canceled the torsion element 7 is not rotated.

The anchor component 2 is at least in regions configured as a hollow body and the torsion element 7 is at least partially or in regions received in the interior of the anchor component 2, which is configured at least in regions as a hollow body. At least in the initial state of the airbag clip 1, an end region 8 of the torsion element 7 projects at least partially or in regions from a wall region of the anchor component 2, which is configured at least in regions as a hollow body.

In particular, it can be seen from the sectional view according to FIG. 12 that a passage opening 9 is formed in the anchor region 3 of the anchor component 2, through which, at least in the initial state of the airbag clip 1, the end region 8 of the torsion element 7 extends at least partially or in regions.

The passage opening 9 formed in the anchor region 3 of the anchor component 2 is positioned and/or formed in the anchor region 3 of the anchor component 2 such that the end region 8 of the torsion element 7, which extends at least partially or in regions through the passage opening 9 at least in the initial state of the airbag clip 1, and that, in the intermediate state of the airbag clip 1 or when transferring the airbag clip 1 from the intermediate state to the mounted state, comes into contact with a wall region surrounding the opening 51 provided in the carrier component 50 and is pressed through the passage opening 9 into the interior of the anchor component 2, which is configured at least in regions as a hollow body.

The cover component 6 can comprise a locking element 10 configured to block movement, in particular linear movement, of the cover component 6 relative to the housing component 5 in a first state of the locking element 10 and to allow movement, in particular linear movement, of the cover component 6 relative to the housing component 5 in a second state of the locking element 10.

In the exemplary embodiment of the airbag clip 1 according to the disclosure shown in the drawings, the locking element 10 is formed by the end region 8 of the torsion element 7 extending at least partially or in regions through the passage opening 9 in the initial state of the airbag clip 1.

From the illustration according to FIG. 11, it can be seen that the cover component 6 comprises linear guides 11, which are configured, at least when transferring the airbag clip 1 from the intermediate state to the mounted state, to interact with corresponding linear guides 12 of the housing component 5, which are formed at least partially or in regions complementarily to the linear guides 11 of the cover component 6, such that the cover component 6 is movable, and in particular linearly movable, relative to the housing component 5 in the longitudinal extension direction of the anchor region 3.

Furthermore, it can be seen in the illustration according to FIG. 11 that the cover component 6 comprises catch means 13, which are configured to cooperate with corresponding counter-catch means 14 of the housing component 5 upon or after transferring the airbag clip 1 from the intermediate state to the mounted state, such that the cover component 6 is fixed to the housing component 5 after its movement relative to the housing component 5 in the longitudinal extension direction of the anchor region 3.

FIG. 8 shows that the anchor component 2, and in particular the bearing region 4 of the anchor component 2, has at least one ramp-shaped region 15.

On the other hand, FIG. 11 shows that the cover component 6 comprises at least one drive region 16 projecting in the longitudinal extension direction of the anchor region 3, which is configured in such a way and cooperates with the at least one ramp-shaped region 15 of the anchor component 2 that, in the case of a movement, and in particular linear movement, of the cover component 6 relative to the housing component 5 in the longitudinal extension direction of the anchor region 3, a torque acting on the anchor component 2 is generated, in particular according to the principle of the inclined plane.

In FIG. 2 and FIG. 3, it is suggested that an end region 8 of the anchor region 3 of the anchor component 2 opposite to the bearing region 4 of the anchor component 2 is configured at least partially or in regions as a guide region 17 with at least one guide surface, which is configured such that upon insertion, and in particular plugging, of the anchor region 3 into the opening 51 provided in the carrier component 50, a torque is generated and introduced into the anchor component 2, such that, starting from the neutral position of the anchor component 2, the anchor component 2 is rotated relative to the housing component 5 in the first rotational direction about the axis of rotation.

On the other hand, FIG. 8 shows that the anchor region 3 of the anchor component 2 between the guide region 17 and the bearing region 4 comprises at least one rib region 18 projecting radially from the anchor region 3 and preferably two rib regions 18 that are opposite each other, each projecting radially from the anchor region 3.

In particular, it is provided that the at least one rib region 18 radially projecting from the anchor region 3 comprises an upper surface facing the bearing region 4 of the anchor component 2 and a lower surface opposite to the upper surface, wherein, in the mounted state of the airbag clip 1, an edge region of the carrier component 50 surrounding the opening 51 provided in the carrier component 50 is at least partially or in regions received between the upper surface of the at least one rib region 18 projecting radially from the anchor region 3 and a downwardly facing surface of the housing component 5.

Furthermore, in particular, it is provided that the at least one rib region 18 radially projecting from the anchor region 3 comprises a upper surface facing the bearing region 4 of the anchor component 2 and a lower surface opposite to the upper surface, wherein the lower surface of the at least one rib region 18 radially projecting from the anchor region 3 and a lower region of the passage opening 9 formed in the anchor region 3 of the anchor component 2 are at least substantially in a common plane perpendicular to the axis of rotation.

The anchor component 2, the housing component 5 and the cover component 6 are each configured as a preferably fiber-reinforced plastic parts, in particular plastic injection-molded parts. In an alternative embodiment, one of the components, in particular the anchor component 2, can be configured as a hybrid component. This may be realized by a directly overmolded metal insert that serves to increase the holding force and mechanical strength, while the outer plastic layer ensures the complex geometries and surface finish. A further advantageous embodiment provides that a plastic base body, for example the anchor component 2, is provided with a galvanically deposited metal coating in order to increase the surface stiffness, the wear resistance of the functional surfaces and the dimensional accuracy.

The illustration according to FIG. 14 shows that the airbag clip 1 comprises an anti-rotation device 19, in particular in the form of a hole/pin combination, which interacts with an edge region of the carrier component 50 surrounding an opening 51 provided in the carrier component 50, which is configured, at least when the airbag clip 1 is transferred from the initial state to the intermediate state, to keep the housing component 5 and the airbag clip 1 rotationally fixed relative to the carrier component 50.

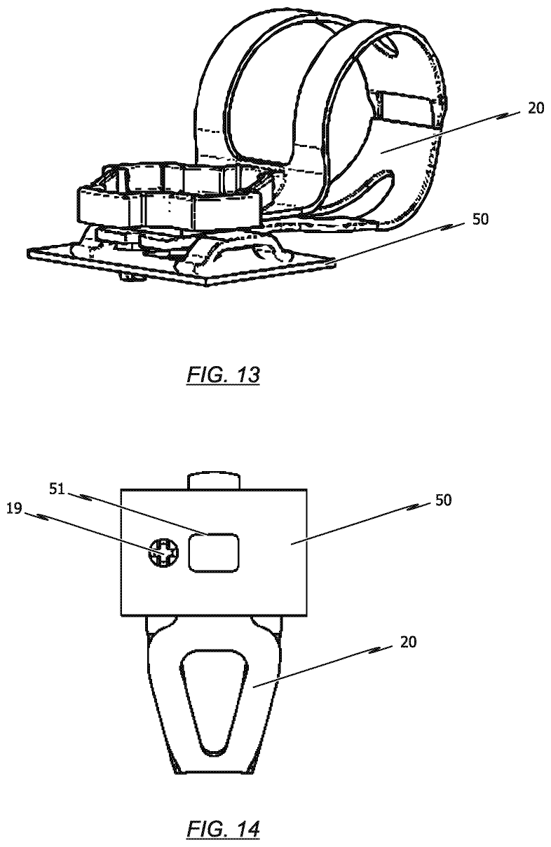

As can be seen in particular in the illustration according to FIG. 13, the airbag clip 1 can comprise an airbag holding component 20, which is in particular releasably connected or connectable to the housing component 5 and/or the cover component 6 of the airbag clip 1.

The disclosure is not limited to the embodiments shown in the drawings, but rather results when all of the features disclosed herein are considered together.

In particular, it is thus conceivable that the airbag clip 1, and in particular the anchor component 2 of the airbag clip 1, are configured for installation in a standard opening 51 provided in a carrier component 50 for airbag mountings, wherein the standard opening 51 for airbag mountings is in particular rectangular with a dimension of about 7.4 mm by 9.4 mm.

On the other hand, it is conceivable that the airbag clip 1 is reversibly transferrable between its initial state and its mounted state.

While the present method and/or system has been described with reference to certain aspects, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular aspects disclosed. Instead, the present method and/or system will include all aspects falling within the scope of the appended claims, both literally and under the doctrine of equivalents.

### LIST OF REFERENCE NUMERALS

1 Arrangement for providing a fastening possibility/torsion clip/airbag clip
2 Anchor component
3 Anchor region of the anchor component
4 Bearing region of the anchor component
5 Housing component
6 Cover component
7 Torsion element
8 End region of the torsion element/release mechanism
9 Passage opening in the anchor region of the anchor component
10 Locking element of the cover component
11 Linear guide of the cover component
12 Linear guide of the housing component
13 Catch means of the cover component
14 Catch means of the housing component
15 Ramp-shaped region of the anchor component
16 Drive region of the cover component
17 Guide region of the anchor region of the anchor component
18 Rib region of the anchor region of the anchor component
19 Anti-rotation device
20 Airbag holding component
50 Carrier component/body
51 Opening in the carrier component
110 Fastening clip (prior art)
112 Head section (prior art)
114 Tenon (prior art)
116 Upper surface of the tenon (prior art)
118 Upper surface of the fastening clip (prior art)

What is claimed is:

1. An assembly (1) for providing a fastening possibility for a component of an airbag system, wherein the assembly (1) is configured as a torsion clip comprising:
an anchor component (2) with an anchor region (3) that is at least partially or in regions at least substantially shaft-shaped or bar-shaped, and with a bearing region (4) connected thereto that is at least substantially flange-shaped or plate-shaped;
a housing component (5), which is configured to receive at least partially or in regions at least the bearing region (4) of the anchor component (2) such that—at least over a previously determined or determinable rotational angle range—the anchor component (2) is rotatably supported relative to the housing component (5) about an axis of rotation extending at least substantially in the longitudinal extension direction of the anchor region (3); and
a cover component (6), which is configured to cover at least partially or in regions the housing component (5) with the bearing region (4) of the anchor component (2) received at least partially or in regions,
wherein the assembly (1) is configured such that the assembly (1), particularly when inserting and plugging the anchor region (3) of the anchor component (2) into an opening (51) provided in a carrier component (50), is or can be transferred from an initial state to an intermediate state and from the intermediate state to a mounted state, wherein the anchor component (2) is configured such that, when transferring the assembly (1) from the initial state to the intermediate state, starting from a neutral position relative to the housing component (5), the anchor component (2) is rotated in a first rotational direction about the axis of rotation, wherein, upon reaching the intermediate state or in the intermediate state of the assembly (1), the anchor component (2) moves back to the neutral position on its own, and wherein, when transferring the assembly (1) from the intermediate state to the mounted state, the anchor component (2), starting from the neutral position relative to the housing component (5), is rotated about the axis of rotation in a second rotational direction opposite to the first rotational direction.

2. The assembly (1) according to claim 1,
wherein the cover component (6) is mounted in a linearly movable manner with respect to the housing component (5) between a first position and a second position, wherein the cover component (6) is in the first position when the assembly (1) is in the intermediate state, and wherein the cover component (6) is in the second position when the assembly (1) is in the mounted state, wherein the assembly (1) is configured such that, for transferring the assembly (1) into the mounted state, a linear movability of the cover component (6) relative to the housing component (5) is permitted only when it is detected by the assembly (1) that the anchor region (3) of the anchor component (2) has been inserted into the opening (51) provided in the carrier component (50), and the assembly (1) has been transferred from the initial state to the intermediate state.

3. The assembly (1) according to claim 2,
wherein the assembly (1) comprises a triggering mechanism (8), which is actuated once the anchor region (3) of the anchor component (2) has been inserted into the opening (51) provided in the carrier component (50), and the assembly (1) has been transferred from the initial state to the intermediate state, wherein, when the triggering mechanism (8) is actuated, the linear movability of the cover component (6) relative to the housing component (5) is enabled.

4. The assembly (1) according to claim 1,
wherein the cover component (6) is arranged in a rotationally fixed manner with respect to the housing component (5) and comprises a torsion element (7), which interacts with the anchor component (2) with the anchor region (3) of the anchor component (2) such that, when the assembly (1) is transferred from the initial state to the intermediate state, the torsion element (7) is rotated so that a torque is generated to move the anchor component (2) back to the neutral position.

5. The assembly (1) according to claim 4,
wherein the torsion element (7) and/or the anchor component (2) is/are configured such that, when the assembly (1) is transferred from the intermediate state to the mounted state, an interaction between the torsion element (7) and the anchor component (2) is canceled so that the torsion element (7) is not rotated.

6. The assembly (1) according to claim 4,
wherein the anchor component (2) is at least partially configured as a hollow body and the torsion element (7) is received at least partially or in regions in the interior of the anchor component (2), which is configured at least in regions as a hollow body, wherein, at least in the initial state of the assembly (1), an end region (8) of the torsion element (7) projects at least partially or in regions from a wall region of the anchor component (2), which is configured at least in regions as a hollow body.

7. The assembly (1) according to claim 6,
wherein a passage opening (9) is formed in the anchor region (3) of the anchor component (2), through which, at least in the initial state of the assembly (1), the end region (8) of the torsion element (7) extends at least partially or in regions.

8. The assembly (1) according to claim 7,
wherein the passage opening (9) formed in the anchor region (3) of the anchor component (2) is positioned and/or formed in the anchor region (3) of the anchor component (2) such that the end region (8) of the torsion element (7), which extends at least partially or in regions through the passage opening (9) at least in the initial state of the assembly (1), and that, in the intermediate state of the assembly (1) or when transferring the assembly (1) from the intermediate state to the mounted state, comes into contact with a wall region surrounding the opening (51) provided in the carrier component (50) and is pressed through the passage opening (9) into the interior of the anchor component (2), which is configured at least in regions as a hollow body.

9. The assembly (1) according to claim 4,
wherein the torsion element (7) comprises an end region (8) which, in the initial state, blocks linear movement of the cover (6) and is configured to allow linear movement of the cover (6) once the anchor (2) is correctly positioned in the opening (51) of the carrier component (50) to provide an installation verification.

10. The assembly (1) according to claim 1,
wherein the cover component (6) comprises a locking element (10) configured to block movement of the cover component (6) relative to the housing component (5) in a first state of the locking element (10) and to allow movement of the cover component (6) relative to the housing component (5) in a second state of the locking element (10).

11. The assembly (1) according to claim 10,
wherein the locking element (10) is formed by the end region (8) of the torsion element (7), which, at least in the initial state of the assembly (1), extends at least partially or in regions through the passage opening (9).

12. The assembly (1) according to claim 1,
wherein the cover component (6) comprises linear guides (11), which are configured, at least when transferring the assembly (1) from its intermediate state to its mounted state, to interact with corresponding linear guides (12) of the housing component (5), which are formed at least partially or in regions complementarily to the linear guides (11) of the cover component (6), such that the cover component (6) is movable relative to the housing component (5) in the longitudinal extension direction of the anchor region (3).

13. The assembly (1) according to claim 12,
wherein the cover component (6) comprises catch means (13), which are configured to cooperate with corresponding counter-catch means (14) of the housing component (5) upon or after transferring the assembly (1) from its intermediate state to its mounted state, such that the cover component (6) is fixed to the housing component (5) after its movement relative to the housing component (5) in the longitudinal extension direction of the anchor region (3).

14. The assembly (1) according to claim 1,
wherein the anchor component (2) comprises at least one ramp-shaped region (15), and wherein the cover component (6) comprises at least one drive region (16) projecting in the longitudinal extension direction of the anchor region (3), which is configured in such a way and cooperates with the at least one ramp-shaped region (15) of the anchor component (2) such that, in the case of a movement of the cover component (6) relative to the housing component (5) in the longitudinal extension direction of the anchor region (3), a torque acting on the anchor component (2) is generated.

15. The assembly (1) according to claim 1,
wherein an end region (8) of the anchor region (3) of the anchor component (2) opposite to the bearing region (4) of the anchor component (2) is configured at least partially or in regions as a guide region (17) with at least one guide surface, which is configured such that upon insertion of the anchor region (3) into the opening (51) provided in the carrier component (50), a torque is generated and introduced into the anchor component (2) such that, starting from the neutral position of the anchor component (2), the anchor component (2) is rotated relative to the housing component (5) in the first rotational direction about the axis of rotation.

16. The assembly (1) according to claim 15,
wherein the anchor region (3) of the anchor component (2) between the guide region (17) and the bearing region (4) comprises at least one rib region (18) protruding radially from the anchor region (3) and two rib regions (18) opposite each other, each protruding radially from the anchor region (3).

17. The assembly (1) according to claim 16,
wherein the at least one rib region (18) radially projecting from the anchor region (3) comprises an upper surface facing the bearing region (4) of the anchor component (2) and a lower surface opposite to the upper surface, wherein, in the mounted state of the assembly (1), an edge region of the carrier component (50) surrounding the opening (51) provided in the carrier component (50) is at least partially or in regions received between the upper surface of the at least one rib region (18) projecting radially from the anchor region (3) and a downwardly facing surface of the housing component (5).

18. The assembly (1) according to claim 16,
wherein the at least one rib region (18) radially projecting from the anchor region (3) comprises an upper surface facing the bearing region (4) of the anchor component (2) and a lower surface opposite to the upper surface, wherein the lower surface of the at least one rib region (18) radially projecting from the anchor region (3) and a lower region of the passage opening (9) formed in the anchor region (3) of the anchor component (2) are at least substantially in a common plane perpendicular to the axis of rotation.

19. The assembly (1) according to claim 1,
wherein the anchor component (2), the housing component (5) and the cover component (6) are each configured as fiber-reinforced plastic parts.

20. The assembly (1) according to claim 19,
wherein a plastic base body of the anchor component (2) and/or the housing component (5) and/or the cover component (6) at least in selected surface regions comprises a galvanically deposited metal coating, which serves to increase the local E modulus.
